(19) United States
(12) Patent Application Publication
(10) Pub. No.: US 2013/0254692 A1
(43) Pub. Date: Sep. 26, 2013

(54) METHOD OF GENERATING AN ELECTRONIC FOLDER AND AN ELECTRONIC DEVICE THEREOF

(71) Applicant: SAMSUNG ELECTRONICS CO., LTD., Gyeonggi-do (KR)

(72) Inventor: Sang-Ho HAN, Seoul (KR)

(73) Assignee: SAMSUNG ELECTRONICS CO., LTD., Gyeonggi-do (KR)

(21) Appl. No.: 13/850,383

(22) Filed: Mar. 26, 2013

(30) Foreign Application Priority Data
Mar. 26, 2012 (KR) 10-2012-0030419

(51) Int. Cl. G06F 3/0481

(52) U.S. Cl. CPC G06F 3/04817
USPC 715/769; 715/825

(57) ABSTRACT

A method generates electronic folders to efficiently classify and store icons and an electronic device therefor. The method includes allowing a user to select any one of a plurality of displayed icons, verifying that the selected icon is clicked for a set time or more, and generating the electronic folders for storing the selected icon.

### CLAIM OF PRIORITY

This application claims, pursuant to 35 U.S.C. §119(a), priority to and the benefit of the earlier filing date of a Korean patent application filed in the Korean Intellectual Property Office on Mar. 26, 2012 and assigned Serial No. 10-2012-0030419, the entire disclosure of which is hereby incorporated by reference.

### BACKGROUND OF THE INVENTION

1. Field of the Invention

The present invention relates to electronic folders, and in particular to a method of generating electronic folders to efficiently classify and store icons in an electronic device and the electronic device thereof.

2. Description of the Related Art

An electronic device may perform a variety of functions while using other technology of the electronic device for different functions. For example, users may watch movies, terrestrial broadcasting, etc., and may execute a variety of applications and may enjoy games and moving pictures. Also, the users may obtain information necessary for their lives, such as news and weather information. Accordingly, in the electronic device, the users need icons for executing respective applications and it is natural that users need more icons in order to execute many functions thereof.

As described above, in order to execute a variety of functions using the electronic device, more icons are generated. One method of efficiently managing and storing a variety of icons stored in the electronic device generates folders and stores the generated folders systematically while being classified according to categories.

However, in order to generate folders in an electronic device in the prior art, there is a problem in that users must perform many steps. For example, if the user selects a menu key or menu icon on a main menu of the electronic device, the electronic device displays a variety of applications and changes a current mode to an editing mode. If the user selects an application to be stored in a folder, the electronic device stores the selected application in the folder. The user drags and moves a generated folder to the main menu. As described above, the user must perform many steps to generate the folder.

### SUMMARY OF THE INVENTION

An aspect of the present invention is to solve at least the above-mentioned problems and/or disadvantages and to provide at least the advantages described below. Accordingly, an aspect of the present invention is to provide an apparatus and method for efficiently classifying and storing icons in an electronic device.

Another aspect of the present invention is to provide an apparatus and method for easily generating folders and effectively storing icons in an electronic device in the generated folders.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIGS. 1A, 1B, 1C and 1D illustrate a process of generating folders according to an exemplary embodiment of the present invention;

FIGS. 2A and 2B illustrate a process of executing a multi-selection mode for selecting a plurality of icons according to the exemplary embodiment of the present invention;

FIGS. 3A and 3B illustrate a process of executing a multi-selection mode for selecting a plurality of icons according to an alternative exemplary embodiment of the present invention;

FIGS. 4A and 4B illustrate a process of executing a multi-selection mode for selecting a plurality of icons according to another alternative exemplary embodiment of the present invention;

FIGS. 5A, 5B and 5C illustrate a process of selecting an icon and storing the selected icon in a folder according to the exemplary embodiment of the present invention;

FIGS. 6A, 6B and 6C illustrate a process of selecting an icon and storing the selected icon in a menu screen according to the exemplary embodiment of the present invention;

FIG. 7 is a flowchart illustrating an operation process of an electronic device which generates folders according to the exemplary embodiment of the present invention; and

FIG. 8 is a block diagram illustrating a configuration of the electronic device according to the exemplary embodiment of the present invention.

### DETAILED DESCRIPTION OF THE INVENTION

Exemplary embodiments of the present invention will be described herein below with reference to the accompanying drawings. In the following description, well-known functions or constructions are not described in detail since they would obscure the invention in unnecessary detail. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

Among the terms set forth herein, a folder refers to an electronic folder which stores and organizes data, computer files, and/or other electronic folders.

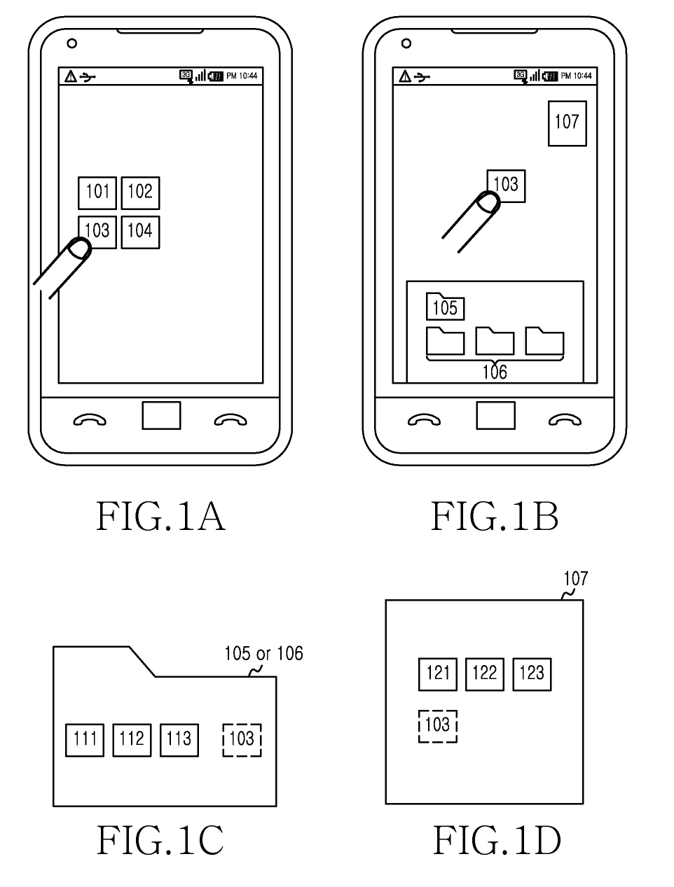

FIGS. 1A, 1B and 1D illustrate a process of generating folders according to an exemplary embodiment of the present invention. Herein, each of the folders is referred to by a name, which may be in English or any other predetermined language, as well as a file folder, and is defined as a place where stored files are to be easily checked. In greater detail, each of the folders is an entity including other folders and files. Each of the folders is defined as a file box which effectively manages files related with each other in a manner similar to a directory of a Disk Operating System (DOS) or UNIX.

An electronic device according to the exemplary embodiment of the present invention generates folders easily to effectively classify and store a variety of icons. An electronic device in the prior art has a problem in that a user must pass through many processes to generate folders. That is, the prior art electronic device does not provide a method of generating folders simply. Accordingly, the user of the prior art electronic device must pass through separate respective processes to generate folders. For example, the user of the prior art electronic device must select a menu key or menu icon on a home screen. If a variety of icons are displayed on the home screen, the user must select a specific icon and must change a current mode of the electronic device to an editing mode. The user must generate folders in the editing mode and must move and store the specific icon selected by the user to the generated folder. Therefore, the user of the prior art electronic device must pass through complex processes. However, the present invention provides an electronic device for easily generating folders according to the exemplary embodiment of the present invention without passing through the above-described prior art complex processes. Accordingly, because the electronic device may efficiently store and classify many icons, the electronic device of the exemplary embodiment of the present invention has an advantage in that convenience of the user is improved.

FIG. 1A illustrates a process of allowing a user to select any one of the icons 101-104 displayed on a home screen of the electronic device according to the exemplary embodiment of the present invention.

If the user turns on the electronic device to generate folders, the home screen is displayed on a touch screen of the electronic device. If the home screen is displayed on the touch screen of the electronic device, a process of generating folders is started. A description will be given in greater detail with reference to conditions shown in FIG. 1A. As shown in FIG. 1A, four icons 101 to 104 are displayed on the home screen of the electronic device. The current conditions of the icons 101-104 and the electronic device indicate that the user wants to move a selected icon 103 of the icons 101-104 displayed on the home screen to a folder and store the icon 103 in the folder. First of all, if the user clicks the selected icon 103 of the four icons 101 to 104 displayed on the home screen for at least a predetermined duration of time set by him or her or alternatively set by default by the manufacturer, as shown in FIG. 1B, folders 105 and 106 capable of storing the icon 103 selected by him or her are generated and displayed on a portion of the home screen, such as a side, a top, a bottom, or any region of the viewable screen. Herein, the folders 105 and 106 are displayed on the bottom of the home screen and include a new folder 105 as well as folders 106 which are previously stored in the electronic device. For example, the new folder 105 is a folder which does not have its own title, and the old folders 106 are folders which have their title designated by the user. The user drags and moves the icon 103 selected by him or her to any one of the new folder 105 and the old folders 106.

FIG. 1C illustrates the new folder 105 or the old folders 106. The icons 111-113 of the new folder 105 or the old folders 106 are pre-existing icons and the icon 103 is an icon which is moved from the home screen to the new folder 105 and the old folders 106.

As described above, if the user selects a specific icon among icons displayed on the home screen and clicks only a selected icon for at least a predetermined duration of time set by him or her or the manufacturer, the electronic device according to the exemplary embodiment of the present invention generates folders on a portion of the home screen. Accordingly, the electronic device has an advantage over the prior art in that convenience of the user is improved. That is, because it is not necessary in the present invention for the user to pass through a plurality of processes to move a specific icon into a selected folder as well as to display a plurality of folders before moving the specific icons, if he or she clicks only the icon selected by him or her for a predetermined duration of time or more, the folders are immediately generated and/or displayed by the exemplary embodiment of the present invention. Also, in accordance with the exemplary embodiment of the present invention, a menu editing region 107 is generated on one part of the home screen at the same time that the folders 105, 106 are generated on the home screen. Herein, the menu editing region 107 is defined as a menu screen shortcut for immediately moving the specific icon 103 to a menu screen and/or for accessing a menu screen which is automatically set to perform editing functions on the specific icon 103. In greater detail, if the user moves the selected icon 103 to the menu editing region 107, the corresponding icon 103 is no longer displayed on the home screen, but is removed from the home screen, and is instead displayed on a menu screen. As described above, the user may move the selected icon 103 into at least one of the folders 105 and 106, or the user may alternatively move the selected icon 103 to the menu editing region 107 and may store the icon 103 in the menu screen. That is, if the user drags and moves the selected icon 103 to the menu editing region 107, the icon 103 is immediately stored in the menu screen.

FIG. 1D illustrates the menu screen. The icons 121-123 of the menu screen are pre-existing icons and the icon 103 is an icon which is moved from the home screen to the menu screen.

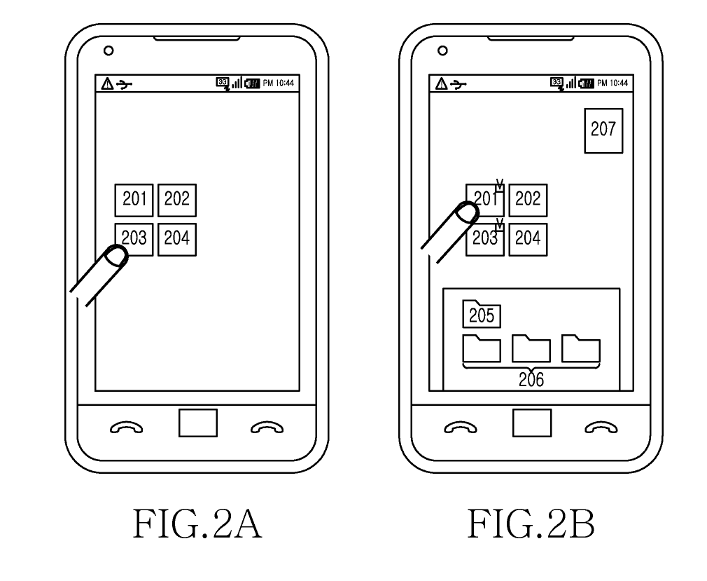

FIGS. 2A and 2B illustrate a process of performing a multi-selection mode for selecting a plurality of icons according to the exemplary embodiment of the present invention. Herein, the multi-selection mode is defined as a mode capable of allowing a user to select a plurality of icons among icons displayed on a home screen. In greater detail, if the user clicks a specific icon among the icons displayed on the home screen for at least a predetermined duration of time set by him or her or the manufacturer, a current mode is changed to the multi-selection mode to select not only the icon selected by him or her but also other icons which are not specifically selected by him or her. The above-described multi-selection mode may be very conveniently used when the user wants to store at least two or more icons in a folder with minimal effort or steps. All of the exemplary embodiments of the present invention support the multi-selection mode such that the user is capable of selecting a plurality of icons. Accordingly, because it is not necessary for the user to store each separate icon in a folder, one at a time as in the prior art, the electronic device according to the exemplary embodiment of the present invention has an advantage in that a plurality of icons which he or she wants may be designated and stored in the folder once; that is, in one step.

Hereinafter, a description will be given with reference to conditions shown in FIGS. 2A and 2B according to the exemplary embodiment of the present invention.

As shown in FIG. 2A, in order to store specific icons 201 and 203 in a folder, if the user turns on an electronic device, a home screen is displayed on a touch screen of the electronic device. The user may verify that four icons 201 to 204 are displayed on the home screen. The user clicks any selected icon 203, which he or she wants to store, among the four icons 201 to 204 displayed on the home screen, for at least a predetermined duration of time set by him or her or the manufacturer. As shown in FIG. 2B, if the electronic device verifies that the selected icon 203 is clicked for the predetermined time or more, the electronic device generates folders 205 and 206 on a portion of the home screen and changes a current mode to a multi-selection mode immediately. The user who verifies that the current mode is changed to the multi-selection mode may select the previously selected icon 203 and another icon 201. If the plurality of icons 201 and 203 are selected by the user, the electronic device puts and displays check marks and/or other indicia selected by the user on the icons 201 and 203 selected by him or her.

In the same manner as described above in conjunction with the examples shown in FIGS. 1A and 1B, referring to FIGS. 2A and 2B, if the plurality of icons 201 and 203 are selected by the user, he or she may store the selected icons 201 and 203 in any one of a new folder 205 and the old folders 206. Also, a menu editing region 207 is also generated on one portion of the home screen at the same time that the folders 205 and 206 are generated. Accordingly, the user may store the plurality of selected icons 201 and 203 in any one of the new folder 205 and the old folders 206. Also, the user may move the icons 201 and 203 to the menu editing region 207 which then may move the icons 201 and 203 to a menu screen.

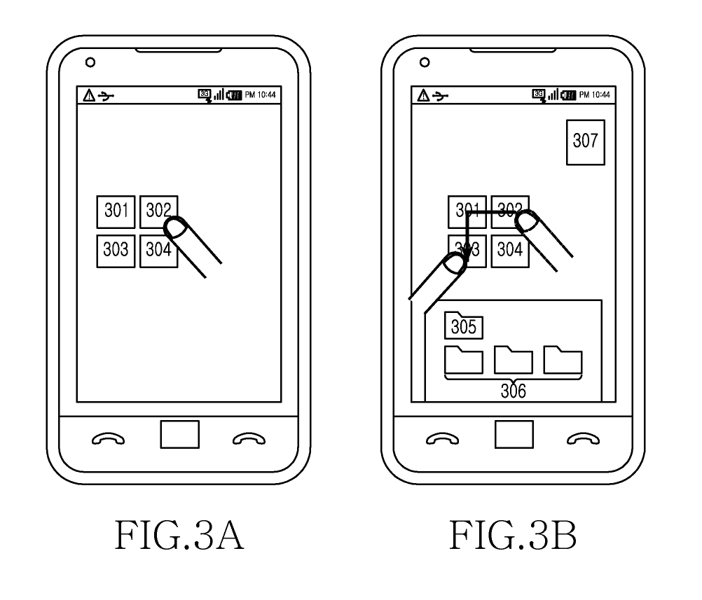

FIGS. 3A and 3B illustrate a process of executing a multi-selection mode for selecting a plurality of icons according to an alternative exemplary embodiment of the present invention. Herein, the multi-selection mode is defined as a mode capable of allowing a user to select a plurality of icons among icons displayed on a home screen. In greater detail, if the user clicks a specific icon among the icons displayed on the home screen for at least a predetermined duration of time set by him or her or the manufacturer, a current mode is changed to the multi-selection mode to select not only the icon selected by him or her but also other icons which are not specifically selected by him or her. The above-described multi-selection mode may be very conveniently used when the user wants to store at least two or more icons in a folder with one step. All of the exemplary embodiments of the present invention support the multi-selection mode such that the user selects a plurality of icons with one step. Accordingly, because it is not necessary for the user to store a separate icon in a folder one at a time as in the prior art, an electronic device according to the alternative exemplary embodiment of the present invention has an advantage in that a plurality of icons which he or her wants may be designated and stored in the folder once; that is, in one step.

Hereinafter, a description will be given with reference to conditions shown in FIGS. 3A and 3B according to the alternative exemplary embodiment of the present invention.

As shown in FIG. 3A, in order to store specific icons 301 to 303 in a folder, if the user turns on an electronic device, a home screen is displayed on a touch screen of the electronic device. The user may verify that four icons 301 to 304 are displayed on the home screen. The user clicks any selected icon 302 he or she wants to store, among the four icons 301 to 304 displayed on the home screen, for a predetermined duration of time set by him or her or the manufacturer. As shown in FIG. 3B, if the electronic device verifies that the one icon is clicked for the predetermined time or more, the electronic device generates folders 305 and 306 on a portion of the home screen and changes a current mode to a multi-selection mode immediately. The user who verifies that the current mode is changed to the multi-selection mode drags the previously selected icon 302 continuously in a state where he or she touches the previously selected icon 302 and may select other icons 301 and 303. If the plurality of 20 icons 301 to 303 are selected by the user, the electronic device verifies that the plurality of icons 301 to 303 are selected by him or her and designates the icons 301 to 303 as one region. That is, the electronic device designates the plurality of icons 301 to 303 as one region such that all the icons 301 to 303 may be moved although the user drags only a selected one of the plurality of icons 301 to 303.

In the same manner as described above in conjunction with the examples shown in FIGS. 1A and 1B, referring to FIGS. 3A and 3B, if the plurality of icons 301 to 303 are selected by the user, he or she may store the selected icons 301 to 303 in any one of a new folder 305 and old folders 306. Also, a menu editing region 307 is also generated on one portion of the home screen at the same time that the folders 305 and 306 are generated. Accordingly, the user may store the plurality of selected icons 301 to 303 in any one of the new folder 305 and the old folders 306. Also, the user may move the icons 301 to 303 to the menu editing region 307 which then may move the icons 301 to 303 to a menu screen.

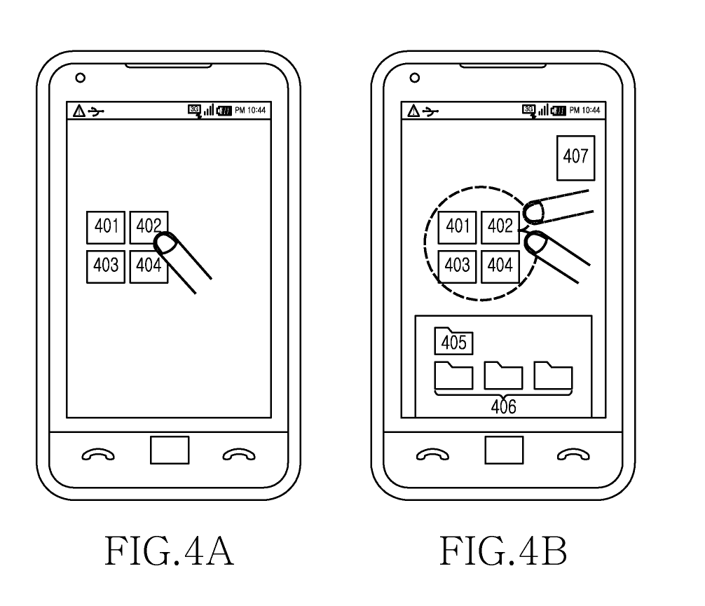

FIGS. 4A and 4B illustrate a process of executing a multi-selection mode for selecting a plurality of icons according to another alternative exemplary embodiment of the present invention. Herein, the multi-selection mode is defined as a mode capable of allowing a user to select a plurality of icons among icons displayed on a home screen. In greater detail, if the user clicks a specific icon among the icons displayed on the home screen for at least a predetermined duration of time set by him or her or the manufacturer, a current mode is changed to the multi-selection mode to select not only the icon selected by him or her but also other icons which are not specifically selected by him or her. The above-described multi-selection mode may be very conveniently used when the user wants to store at least two or more icons in a folder. All of the exemplary embodiments of the present invention support the multi-selection mode such that the user selects a plurality of icons. Accordingly, because it is not necessary for the user to store a separate icon in a folder one at a time as in the prior art, the electronic device according to the another alternative exemplary embodiment of the present invention has an advantage in that a plurality of icons he or her wants may be designated and stored in the folder once; that is, in one step.

Hereinafter, a description will be given with reference to conditions shown in FIGS. 4A and 4B according to another alternative exemplary embodiment of the present invention.

As shown in FIG. 4A, in order to store specific icons 401 to 404 in a folder, if the user turns on an electronic device, a home screen is displayed on a touch screen of the electronic device. The user may verify that four icons 401 to 404 are displayed on the home screen. The user clicks any selected icon 402 he or she wants to store, from among the four icons 401 to 404 displayed on the home screen, for at least a predetermined duration of time set by him or her or the manufacturer. As shown in FIG. 4B, if the electronic device verifies that the selected icon is clicked for the predetermined time or more, the electronic device generates folders 405 and 406 on a portion of the home screen and changes a current mode to a multi-selection mode immediately. The user who verifies that the current mode is changed to the multi-selection mode draws a big circle or other known or arbitrary shapes on the screen by touching the screen and moving the touch input to define the circle or other shapes, such that all the icons 401 to 404 to be selected are included in the big circle or shape, in a state where he or she continually touches the home screen to define the circle or shape, and may thus select the plurality of icons 401 to 404. If the plurality of icons 401 to 404 are selected by the user, the electronic device verifies that the plurality of icons 401 to 404 are selected by him or her and designates any icons 401 to 404 in the circle or shape as one region. That is, the electronic device designates the plurality of icons 401 to 404 as one region such that all the icons 401 to 404 may be moved although the user drags only a selected one of the plurality of icons 401 to 404.

In the same manner as described above in conjunction with the examples shown in FIGS. 1A and 1B, referring to FIGS. 4A and 4B, if the plurality of icons 401 to 404 are selected by the user, he or she may store the selected icons 401 to 404 in any one of a new folder 405 and old folders 406. Also, a menu editing region 407 is also generated on one portion of the home screen at the same time that the folders 405 and 406 are generated. Accordingly, the user may store the plurality of selected icons 401 to 404 in any one of the new folder 405 and the old folders 406. Also, the user may move the icons 401 to 404 to the menu editing region 407 which then may move the icons 401 to 404 to a menu screen.

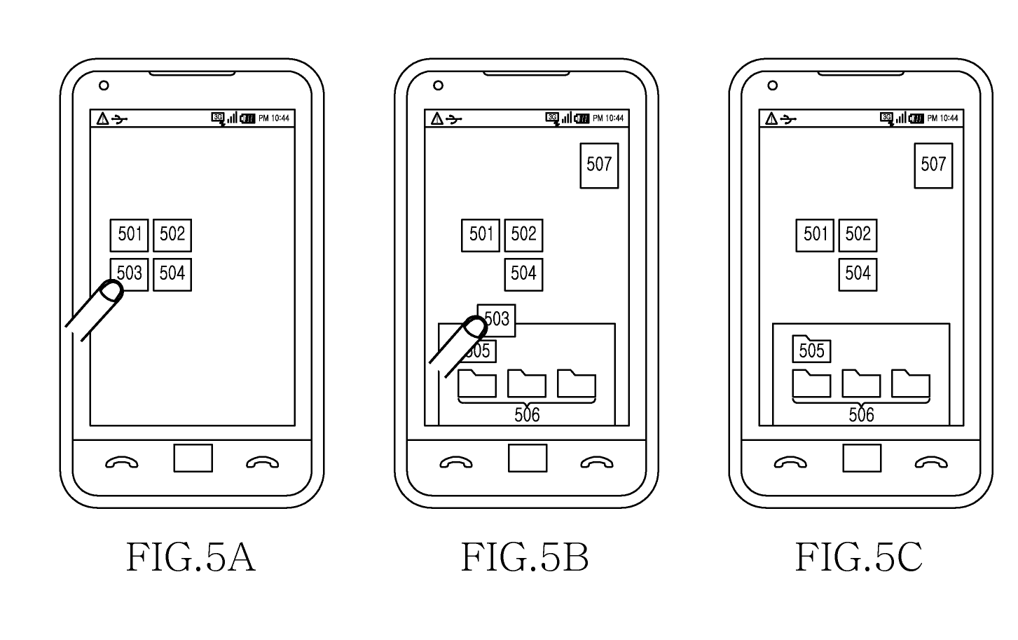

FIGS. 5A to 5C illustrate a process of selecting an icon and storing the selected icon in a folder according to the exemplary embodiment of the present invention.

The electronic device according to the exemplary embodiment of the present invention generates folders easily to efficiently classify and store a variety of icons. An electronic device in the prior art has a problem in that a user must pass through many processes to generate folders. That is, the prior art electronic device does not provide a method of generating folders simply. Accordingly, the user of the prior art electronic device must pass through separate respective processes to generate folders. For example, the user of the prior art electronic device must select a menu key or menu icon on a home screen. If a variety of icons are displayed on the home screen, the user must select a specific icon and must change a current mode to an editing mode. The user must generate folders in the editing mode and must move and store the specific icon selected by the user to the generated folder. Therefore, the user of the prior art electronic device must pass through complex processes. The electronic device for easily generating folders according to the exemplary embodiment of the present invention operates without passing through the above-described prior art complex processes. Accordingly, because the electronic device may efficiently store and classify many icons, the electronic device of the exemplary embodiment of the present invention has an advantage in that convenience of the user is improved.

FIG. 5A illustrates a process of allowing a user to select any one of the icons displayed on a home screen according to the exemplary embodiment of the present invention.

If the user turns on the electronic device to generate folders, the home screen is displayed on a touch screen of the electronic device. If the home screen is displayed on the touch screen of the electronic device, a process of generating folders is started. A description will be given in greater detail with reference to the conditions initially shown in FIG. 5A. As shown in FIG. 5A, four icons 501 to 504 are displayed on the home screen of the electronic device. The current conditions indicate that the user wants to move and store a selected icon 503 of the icons 501 to 504 displayed on the home screen in a folder. First of all, if the user clicks the selected icon 503 of the four icons 501 to 504 displayed on the home screen for at least a predetermined duration of time set by him or her or the manufacturer, as shown in FIG. 5B, folders 505 and 506 capable of storing the icon 503 selected by him or her are displayed on a portion of the home screen. Herein, the folders 505 and 506 displayed on the portion of the home screen include the new folder 505 and the old folders 506 which are previously stored in the electronic device. That is, the new folder 505 is a folder which does not have its own title, and the old folders 506 are folders which have their title designated by the user. When the user wants to store the selected icon 503 in the new folder 505, he or she drags and moves the selected icon 503 to the new folder 505.

As described above, if the user selects a specific icon 503 among icons 501-504 displayed on the home screen and clicks only the selected icon 503 for at least the predetermined duration of time set by him or her or the manufacturer, the electronic device according to the exemplary embodiment of the present invention generates folders on a portion of the home screen. Accordingly, the electronic device has an advantage in that convenience of the user is improved. That is, because it is not necessary for the user to pass through a plurality of complex processes to move a specific icon to a folder, if he or she clicks only the icon selected by him or her for the predetermined duration of time or more, the folders are immediately generated. Also, in accordance with the exemplary embodiment of the present invention, a menu editing region 507 is also generated on one portion of the home screen at the same time that the folders 505, 506 are generated on the home screen. Herein, the menu editing region 507 is defined as a menu screen shortcut for immediately moving a specific icon to a menu screen. In greater detail, if the user moves the selected icon 503 to the menu editing region 507, the corresponding icon is not displayed on the home screen and is displayed on a menu screen. As described above, the user may move the selected icon 503 to one of the folders 505, 506, or the user may also move the selected icon 503 to the menu editing region 507 and may store the icon 503 in the menu screen. That is, if the user drags and moves the selected icon 503 to the menu editing region 507, the icon 503 is immediately stored in the menu screen.

FIG. 5C illustrates a home screen after an icon selected by a user is stored in a folder.

In greater detail, if the icon 503 selected by the user is stored in a new folder 505 through the above-described process, the electronic device displays generated folders 505 and 506 on a portion of the home screen. That is, the other three icons 501, 502, and 504, except for the icon 503 stored in the new folder 505, are displayed on the home screen, from among four icons 501 to 504 previously displayed on the home screen. Accordingly, the user selects the folder 505 displayed on the portion of the home screen to access, display and/or execute the icon 503 stored in the folder 505 at a later time and selects the icons stored in the folder 505. Once the icon 503 is moved to the folder 505, as shown in FIGS. 5A-5C, the menu editing region 507 may be greyed out, deleted, and/or caused to disappear from the screen shown in FIG. 5C until the icon 503 is completely moved into the folder 505, since the option for using, moving, or editing the icon 503 through the home screen is not available once the icon 503 is moved into the folder 505 and, in turn, removed from the home screen. However, after the moving of the icon 503 into folder 505 is completed, the menu editing region 507 may be restored to its original appearance, as shown in FIGS. 5A-5C, to allow any remaining icons 501, 502, 504 on the home screen to be selected and edited by being moved to the menu editing region.

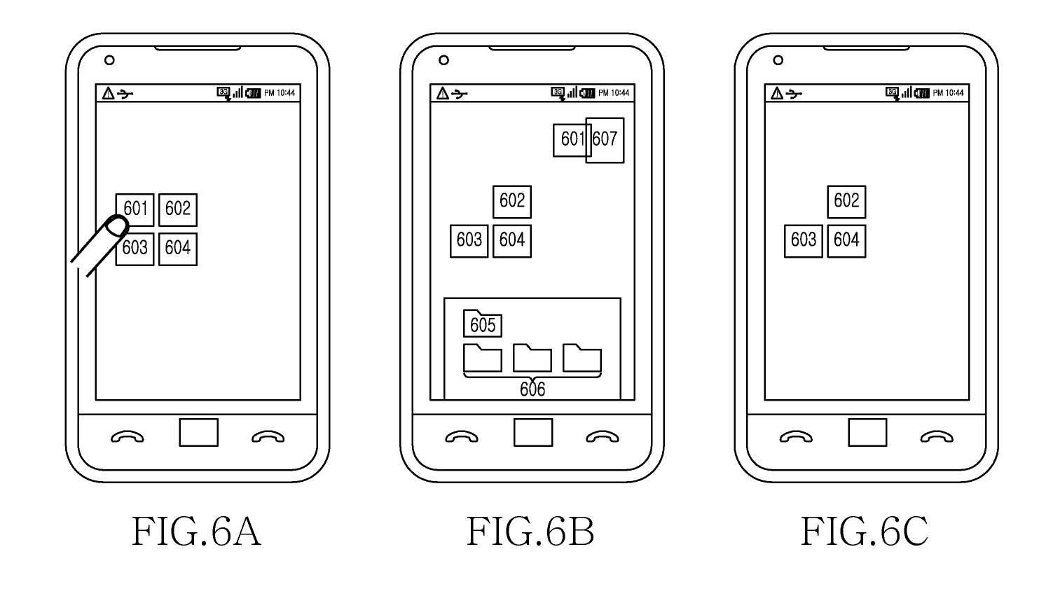

FIGS. 6A to 6C illustrate a process of selecting an icon and storing the selected icon in a menu screen according to the exemplary embodiment of the present invention.

Hereinafter, in the case that a user wants to any one of icons displayed on a home screen to be stored in a menu screen, a description will be given in greater detail.

First of all, as shown in FIG. 6A, four icons 601 to 604 are displayed on a home screen displayed on a touch screen of an electronic device. The user selects a corresponding icon 601 to move the selected icon 601 of the four icons 601 to 604 displayed on the home screen to the menu screen. If the user clicks the selected icon 601 for at least a predetermined duration of time set by him or her or the manufacturer, as shown in FIG. 6B, folders 605 and 606 capable of storing the corresponding icon 601 are displayed on a portion of the home screen. A menu editing region 607 capable of moving the corresponding icon 601 to the menu screen is displayed on one portion of the home screen. If the user drags and moves the selected icon 601 to the menu editing region 607, the corresponding icon 601 is automatically moved to the menu screen. In greater detail, the electronic device according to the exemplary embodiment of the present invention may generate folders easily and automatically and may move the icon selected by the user to the menu screen easily and automatically. That is, the user selects at least one of the icons displayed on the home screen, may store the selected icon in a folder, and/or may move the selected icon to the menu screen.

In the exemplary embodiment shown in FIGS. 6A-6C, once the selected icon 601 is moved to the menu editing region 607, as in FIG. 6B, the electronic device may remove or delete both of the icon 601 and the menu editing region 607 from being displayed on the home screen, while the remaining icons 602-604 continue to be displayed on the home screen, as shown in FIG. 6C.

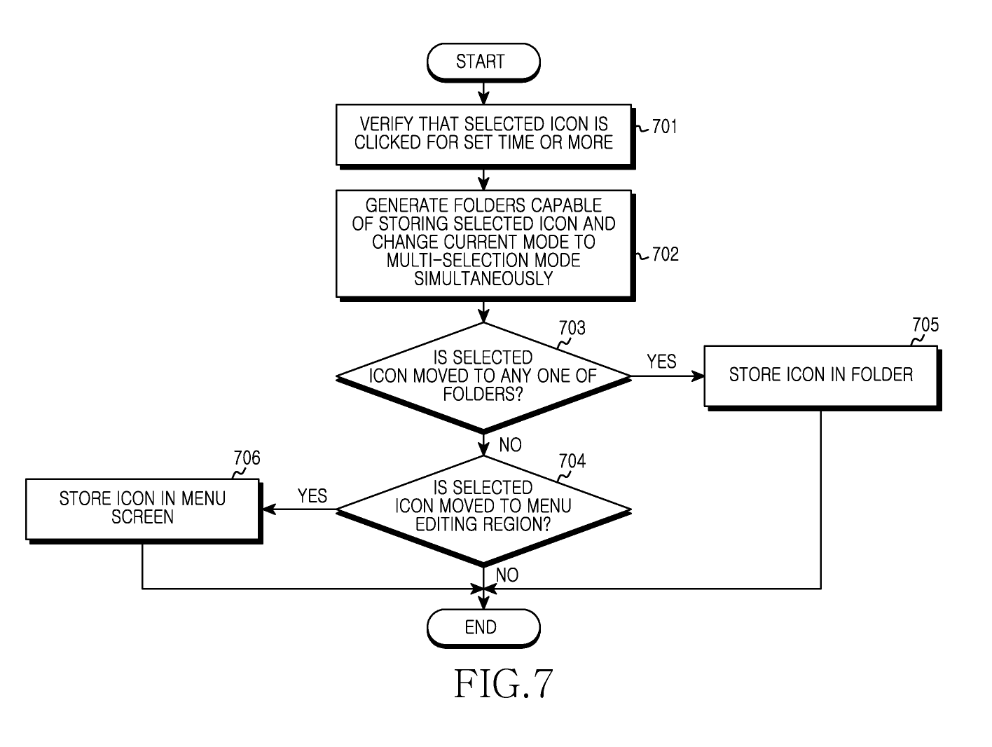

FIG. 7 is a flowchart illustrating an operation process of the electronic device which generates folders according to the exemplary embodiment of the present invention.

As shown in FIG. 7, the electronic device verifies that a selected icon is clicked for the predetermined duration of time or more in step 701. In greater detail, the electronic device allows a user to select any one of a plurality of icons displayed on a home screen displayed on a touch screen thereof Thereafter, the electronic device verifies whether the icon selected by the user is clicked for the predetermined time or more.

If it is verified that the selected icon is clicked for the predetermined duration of time or more, the electronic device generates folders capable of storing the selected icon and changes a current mode to a multi-selection mode simultaneously in step 702. In greater detail, the electronic device according to the exemplary embodiment of the present invention verifies that any one of the icons displayed on the home screen is clicked for at least the predetermined time set by the user or the manufacturer, and the electronic device immediately generates the folders capable of storing the icons clicked for the predetermined time or more. Also, a menu editing region capable of moving the selected icon to a menu screen is displayed together with the icons on one portion of the home screen. That is, an electronic device in the prior art has a problem that complex processes pass through to generate folders. However, as described above, in the present invention, if it is verified that the icon selected by the user is clicked for the predetermined time or more among the icons displayed on the home screen, the electronic device according to the exemplary embodiment of the present invention has an advantage in that folders are immediately generated and convenience of the user is improved.

The electronic device determines whether the selected icon is moved to any one of the folders in step 703. In greater detail, the electronic device determines in step 703 whether the icon selected by the user is moved to the folder generated on a portion of the home screen in step 702. Herein, the folders may include a new folder whose title is not designated and/or old folders whose titles are designated. That is, the electronic device generates all folders to store the icon selected by the user in a new folder or an older folder.

If the electronic device determines in step 703 that the icon selected by the user is not moved to a selected folder, the electronic device determines whether the selected icon is moved to the menu editing region in step 704. In greater detail, as described above, the menu editing region capable of moving the icon selected by the user to the menu screen is displayed on one portion of the home screen at the same time that the folders are generated on a portion of the home screen. That is, the electronic device determines whether the icon selected by the user is moved to the menu editing region. If the electronic device determines that the icon selected by the user is not moved to the menu editing region in step 704, the electronic device ends the process of FIG. 7. Alternatively, the electronic device loops back to step 701 to process other selected icons on the home screen.

However, if the electronic device determines that the icon selected by the user is moved to the menu editing region in step 704, the electronic device stores the corresponding icon in the menu screen in step 706. In addition, the icon moved to the menu editing region is then deleted from the home screen. Thereafter, the corresponding icon is displayed on the menu screen. The electronic device then ends the process of FIG. 7. Alternatively, the electronic device loops back to step 701 to process other selected icons on the home screen.

Referring back to step 703, if the electronic device determines that the icon selected by the user is moved to a selected folder in step 703, the electronic device stores the corresponding icon in the selected folder in step 705. That is, the icon stored in the folder is deleted from the home screen. The corresponding icon is stored in the folder and the folder itself is displayed on the home screen.

Accordingly, when the user wants to execute the corresponding icon, he or she may select the folder displayed on the home screen and may execute the corresponding icon. After step 705 is performed, the electronic device then ends the process of FIG. 7. Alternatively, the electronic device loops back to step 701 to process other selected icons on the home screen.

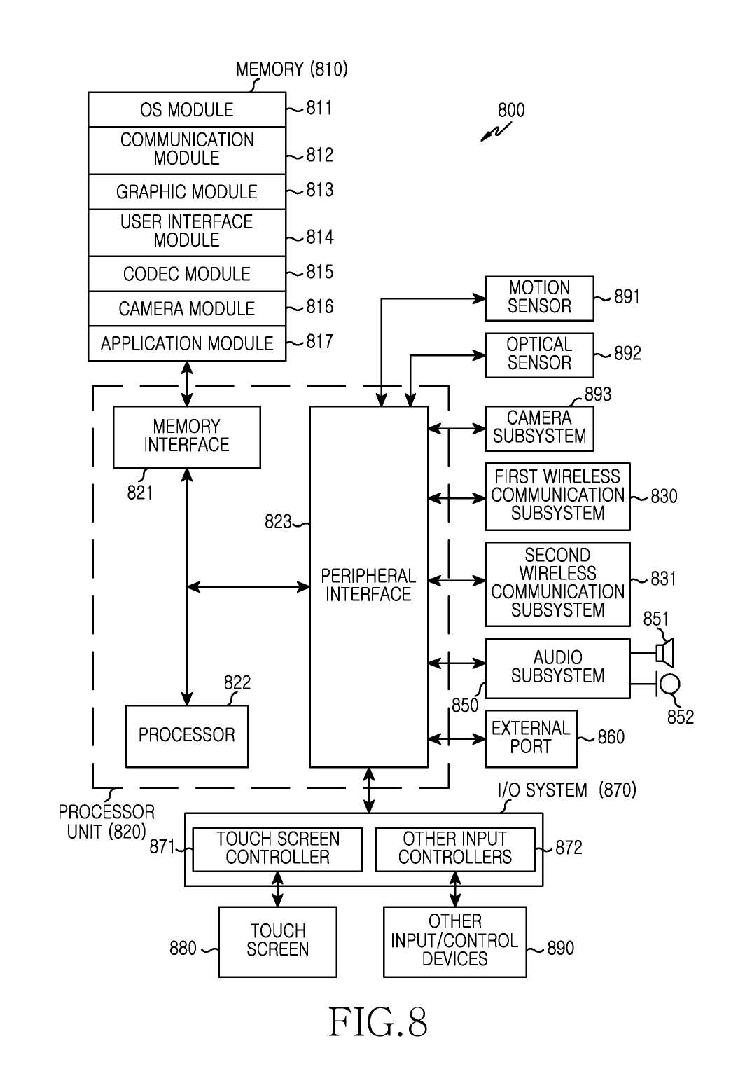

FIG. 8 is a block diagram illustrating a configuration of an electronic device according to the exemplary embodiment of the present invention.

In the exemplary embodiments of the present invention, the electronic device 800 may be a portable electronic device. The electronic device 800 may be a portable terminal, a mobile phone, a mobile pad, a media player, a tablet computer, a handheld computer, or a Personal Digital Assistant (PDA). Also, the electronic device 800 may be any known portable electronic device including a device in which two or more functions are combined among these devices.

This electronic device 800 includes a memory 810, a processor unit 820, a first wireless communication subsystem 830, a second wireless communication subsystem 831, an external port 860, an audio subsystem 850, a speaker 851, a microphone 852, an Input/Output (I/O) system 870, a touch screen 880, other input/control devices 890, a motion sensor 891, an optical sensor 892, and a camera subsystem 893. The memory 810 and the external port 860 may be a plurality of memories and external ports, respectively.

The processor unit 820 may include a memory interface 821, one or more processors 822, and a peripheral interface 823. In some cases, the whole processor unit 820 is referred to as a processor. The memory interface 821 may be separately configured, for example, as separate and distinct components, from the processor 822 and/or the peripheral interface 823, or may be integrated into at least one integrated circuit. In accordance with the exemplary embodiment of the present invention, the processor unit 820 verifies that a selected icon is clicked for a predetermined duration of time or more, generates folders capable of storing the selected icon, and changes the current mode to a multi-selection mode capable of allowing a user to select at least two or more icons among displayed icons. Also, the processor unit 820 verifies that a specific region is designated, verifies icons which are positioned on the specific region, and verifies that at least the two or more verified icons are selected. Also, the processor unit 820 generates a menu editing region, verifies that the selected icon is dragged and moved to the menu editing region, and moves the icon to a menu screen. Also, the processor unit 820 verifies that the selected icon is dragged and moved to a selected folder and stores the icon in the folder. The stored icons, folders, and associated files are stored in the memory 810.

The processor 822 executes several software programs and performs several functions for the electronic device 800. Also, the processor 822 performs process and control for voice communication and data communication. Also, in addition to normal or typical functions of the electronic device 800, the processor 822 executes a specific software module, which may be an instruction set and/or command set, stored in the memory 810 and plays a role in performing several specific functions corresponding to the software module. That is, the processor 822 interacts with the software modules 811-817 stored in the memory 810 and performs the method according to the exemplary embodiment of the present invention.

The processor 822 may include one or more data processors, an image processor, or a codec. The processor 822 may separately include the data processors, the image processor, or the codec. Also, the processor 822 may include several processors for performing different functions. The peripheral interface 823 connects the I/O system 870 of the electronic device 800 and several peripheral devices to the processor 822 and also to the memory 810, for example, though the memory interface 821.

A variety of components of the electronic device 800 may be coupled by one or more communication buses, stream lines or paths for data transfers and streaming, which are illustrated by the arrows and connections between the components in FIG. 8.

The external port 860 is used to connect the electronic device 800 to another electronic device directly or connect the electronic device 800 to another electronic device indirectly through a network (e.g., the Internet, an intranet, a wireless Local Area Network (LAN), etc.). For example, the external port 860 may include, but is not limited to, any one of a Universal Serial Bus (USB) port, an IEEE 1394 compatible port, a FIREWIRE port as a port implementing a serial bus interface standard for high-speed communications and isochronous real-time data transfer, commercially available from APPLE CORPORATION, etc.

The motion sensor 891 and the optical sensor 892 may connect to the peripheral interface 823 and may perform several functions. For example, the motion sensor 891 and the optical sensor 892 may connect to the peripheral interface 823, may sense motion of the electronic device 800, and may sense light from outside the electronic device 800. Furthermore, a position measurement system and other sensors such as a temperature sensor, a bio-sensor, etc. may connect to the peripheral interface 823 and may perform related functions.

The camera subsystem 893 may perform a camera function such as a photo and video clip recording function.

The optical sensor 892 may be a Charge Coupled Device (CCD) or a Complementary Metal-Oxide Semiconductor (CMOS) device.

A communication function is performed through the first wireless communication subsystem 830 and the second wireless communication subsystem 831. Each of the first wireless communication subsystem 830 and the second wireless communication subsystem 831 may include a radio frequency receiver and transmitter and/or a beam or electromagnetic wave receiver and transmitter, for example, to receive and transmit infrared rays. The first communication subsystem 830 and the second communication subsystem 831 may be classified according to a communication network through which the electronic device 800 communicates. For example, the communication network may be, but is not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wi-Fi network, a WiMax network, or/and a Bluetooth network. Each of the first communication subsystem 830 and the second communication subsystem 831 may include a communication subsystem designed to be operated through the communication network. Herein, in accordance with the exemplary embodiment of the present invention, because it is necessary to perform Wi-Fi communications through the Wi-Fi network, one of the first wireless communication subsystem 830 and the second wireless communication subsystem 831 may be operated through the Wi-Fi network. The first wireless communication subsystem 830 and the second wireless communication subsystem 831 may be combined and configured as one wireless communication subsystem.

The audio subsystem 850 may connect to the speaker 851 and the microphone 852 and may be responsible for inputting and outputting an audio stream, such as for performing a voice recognition function, a voice copy function, a digital recording function, and a phone call function. That is, the audio subsystem 850 communicates with a user through the speaker 851 and the microphone 852. The audio subsystem 850 receives a data stream through the peripheral interface 823 of the processor unit 820 and converts the received data stream into an electric stream or signal. The converted electric stream or signal is transmitted to the speaker 851. The speaker 851 converts the electric stream or signal into a sound wave to which a user may listen and outputs the converted sound wave. The microphone 852 converts a sound wave transmitted from the user or other sound sources into an electric stream or signal. The audio subsystem 850 receives the converted electric stream from the microphone 852. The audio subsystem 850 converts the received electric stream into an audio data stream and transmits the converted audio data stream to the peripheral interface 823. The audio subsystem 850 may include an attachable and/or detachable earphone, headphone, and/or headset.

The I/O system 870 may include a touch screen controller 871 and/or other input controllers 872. The touch screen controller 871 may be coupled to the touch screen 880. The touch screen 880 and the touch screen controller 871 may detect, but are not limited to, contact and motion or stopping of such contact or motion using not only capacitive, resistive, infrared ray, and surface acoustic wave technologies for determining one or more contact points but also any known multi-touch sensing technology including other proximity sensor arrangements or other elements. The other input controllers 872 may be coupled to the other input/control devices 890. The other input/control devices 890 may be pointer devices such as one or more buttons, a rocket switch, a thumb-wheel, a dial, a stick, and/or a stylus.

The touch screen 880 provides an input/output interface between the electronic device 800 and the user. That is, the touch screen 880 transmits a touch input of the user to the electronic device 800. Also, the touch screen 880 is a medium for displaying an output from the electronic device 800 to the user. That is, the touch screen 880 displays a visual output to the user. This visual output has a text type, a graphic type, a video type, and/or a combined type of such text, graphic, and video types.

The touch screen 880 may be several displays. For example, the touch screen 880 may be, but is not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The touch screen 880 according to the exemplary embodiment of the present invention allows the user to select any one of a plurality of displayed icons. The touch screen 880 also allows the user to select at least two or more icons at the same time. The touch screen 880 also allows the user to select respective icons separately. The touch screen 880 also allows the user to select icons by a continuous drag operation.

The memory 810 may be coupled to the memory interface 821. The memory 810 may include a high-speed Random Access Memory (RAM) such as one or more magnetic storages, a non-volatile memory, one or more optical storages, and/or a flash memory (e.g., a NAND flash memory or a NOR flash memory).

The memory 810 stores software components and data. The software components include an Operating System (OS) module 811, a communication module 812, a graphic module 813, a user interface module 814, a CODEC module 815, a camera module 816, one or more application modules 817, etc. Also, the modules which are the software components may be expressed in a set of instructions. Accordingly, the modules may be expressed in an instruction set. Also, the modules may be expressed in programs or applications.

The OS module 811 (e.g., embedded OS such as Windows, Linux, Darwin, RTXC, UNIX, OS X, or VxWorks) includes several software components for controlling a general system operation. For example, control of this general system operation means memory management and control, storage hardware and device control and management, power control and management, etc. This OS module 811 also performs a function for smoothly communicating between several hardware and devices, and software components and modules.

The communication module 812 may communicate with other electronic devices such as a computer, a server, and/or a portable terminal through the first wireless communication subsystem 830, the second wireless communication subsystem 831, and/or the external port 860.

The graphic module 813 includes several software components for providing and displaying graphics on the touch screen 880. The term “graphics” includes texts, web pages, icons, digital images, videos, animations, etc. The touch screen 880 according to the exemplary embodiment of the present invention allows the user to select any one of displayed icons. The touch screen 880 also allows the user to select at least two or more icons. The touch screen 880 also allows the user to select respective icons separately. The touch screen 880 also allows the user to select icons by a continuous drag operation.

The user interface module 814 includes several software components related to a user interface. The user interface module 814 includes contents about whether a state of a user interface is changed to any state, whether a state of a user interface is changed in any condition, etc.

The CODEC module 815 may include software components related to encoding and decoding of video files. The CODEC module 815 may include a video stream module such as an MPEG module and/or an H204 module. Also, the CODEC module 815 may include a code module for several audio files such as AAA files, AMR files, and WMA files. Also, the CODEC module 815 includes an instruction set corresponding to the exemplary embodiment of the present invention.

The camera module 816 includes cameral-related software components capable of performing camera-related processes and functions.

The application module 817 includes at least one of a browser function, an email function, an instant message function, a word processing function, a keyboard emulation function, an address book function, a touch list function, a widget function, a Digital Rights Management (DRM) function, a voice recognition function, a voice copy function, a position determining function, a location based service function, etc.

A variety of functions of the electronic device 800, which are described herein, may be executed by one or more of data streaming processes, hardware including an Application Specific Integrated Circuit (ASIC), software, and/or combination of such processes, hardware, and software.

The above-described apparatus and methods according to the present invention can be implemented in hardware, firmware or as software or computer code that can be stored in a non-transitory recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An operation method for operating an electronic device, the operation method comprising:
selecting an icon from a plurality of displayed icons on a display of the electronic device;
determining that the selected icon is selected for a predetermined time or more; and
generating a folder in a memory of the electronic device for storing the selected icon.

2. The operation method of claim 1, further comprising:
changing a current mode to a multi-selection mode for allowing a selecting of at least two or more icons among the displayed icons; and
selecting the at least two or more icons.

3. The operation method of claim 2, wherein the selecting of the at least two or more icons comprises selecting the respective icons separately.

4. The operation method of claim 2, wherein the selecting of the at least two or more icons comprises:
verifying that a specific region on the display is designated;
verifying at least one of the at least two or more icons is positioned on the specific region; and
verifying that at least the two or more verified icons are selected.

5. The operation method of claim 2, wherein the selecting of the at least two or more icons comprises selecting the at least two or more icons by a continuous drag operation.

6. The operation method of claim 1, wherein the generating of the folder for storing the selected icon comprises simultaneously generating a menu editing region on the display.

7. The operation method of claim 6, further comprising:
verifying that the selected icon is dragged and moved to the menu editing region; and
moving the icon to a menu screen.

8. The operation method of claim 1, further comprising;
verifying that the selected icon is dragged and moved to the folder; and
storing the selected icon in the folder.

9. The operation method of claim 1, wherein the folder includes a new folder or at least one old folder which is previously stored.

10. An electronic device comprising:
a memory;
a touch screen for allowing a selection of an icon of a plurality of displayed icons; and
a processor unit for verifying that the selected icon is selected for a predetermined time or more and generating a folder in the memory for storing the selected icon.

11. The electronic device of claim 10, wherein the processor unit changes a current mode to a multi-selection mode for allowing selection of at least two or more icons among the displayed icons and wherein the touch screen allows selection of the at least two or more icons.

12. The electronic device of claim 11, wherein the touch screen allows selection of the respective icons separately.

13. The electronic device of claim 11, wherein the processor unit verifies that a specific region on the touch screen is designated, verifies at least one of the at least two or more icons is positioned on the specific region, and verifies that at least the two or more verified icons are selected.

14. The electronic device of claim 11, wherein the touch screen allows selection of the at least two or more icons by a continuous drag operation.

15. The electronic device of claim 10, wherein the processor unit generates a menu editing region simultaneously with storing the selected icon.

16. The electronic device of claim 15, wherein the processor unit verifies that the selected icon is dragged and moved to the menu editing region and moves the icon to a menu screen.

17. The electronic device of claim 10, wherein the processor unit verifies that the selected icon is dragged and moved to the folder and stores the icon in the folder.

18. The electronic device of claim 10, wherein the folder includes a new folder or at least one old folder which is previously stored.
